(19) United States
(12) Patent Application Publication
(10) Pub. No.: US 2021/0036958 A1
(43) Pub. Date: Feb. 4, 2021

(54) DEVICE, AND COMMUNICATION METHOD

(71) Applicant: FUJITSU LIMITED, Kawasaki-shi (JP)

(72) Inventor: Toshihiko Kurita, Kawasaki (JP)

(73) Assignee: FUJITSU LIMITED, Kawasaki-shi (JP)

(21) Appl. No.: 16/929,165

(22) Filed: Jul. 15, 2020

(30) Foreign Application Priority Data
Jul. 31, 2019 (JP) 2019-141148

(51) Int. Cl. H04L 12/803; H04L 12/801

(52) U.S. Cl. CPC H04L 47/125; H04L 47/11

(57) ABSTRACT

A device includes a memory and a processor coupled to the memory. The processor configured to select a certain terminal from a terminal group accommodated by the device when detecting that an operational state of the device coupled to information-centric networking is an overload state, and to switch an accommodation destination of the certain terminal to another device adjacent to the device.

### CROSS-REFERENCE TO RELATED APPLICATION

This application is based upon and claims the benefit of priority of the prior Japanese Patent Application No. 2019-141148, filed on Jul. 31, 2019, the entire contents of which are incorporated herein by reference.

### FIELD

The embodiments discussed herein are related to a device and, a communication method.

### BACKGROUND

A networking technology called information-centric networking (ICN) has attracted much attention. In ICN, content is requested by specifying the name of the content (content name) instead of the place (node), so that the content is delivered to a user.

ICN is virtual networking that is implemented on top of Internet Protocol (IP) networking. ICN has a feature that even when a node storing content moves, the content may be acquired by requesting the content using the content name in the same way as before the movement, without paying attention to the node after the movement.

As techniques related to content transfer, for example, a technique has been proposed to control a stream delivery path based on a result of evaluation of the delivery quality of stream delivery. Another technique has been proposed. In this technique, when the available bandwidth of a logical network for transmitting content varies, the logical network is changed so that the available bandwidth is greater than or equal to a predetermined margin. Another technique has been proposed. In this technique, a load is detected based on the number of inter-task communications, so that an overload state in a packet receiving process is detected.

Examples of the related art include Japanese Laid-open Patent Publication No. 2003-258885, Japanese Laid-open Patent Publication No. 2015-226235, and Japanese Laid-open Patent Publication No. 2006-333292.

### SUMMARY

According to an aspect of the embodiments, a device includes a memory, and a processor coupled to the memory and configured to, when detecting that an operational state of the device coupled to information-centric networking is an overload state, select a certain terminal from a terminal group accommodated by the device, and to switch an accommodation destination of the certain terminal to another device adjacent to the device.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an example of a communication device;

FIG. 2 is a diagram illustrating an example of operations in information-centric networking (ICN);

FIG. 3 is a diagram illustrating an example of a configuration of a communication system according to an embodiment;

FIG. 4 is a diagram illustrating an example of a hardware configuration of a node;

FIG. 5 is a diagram illustrating an example of functional blocks of a node;

FIG. 6 is a diagram illustrating an example of operations during content transfer;

FIG. 7 is a diagram illustrating an example of operations when an overload is detected and switching of the accommodation destination node of a terminal is performed;

FIG. 8 is a diagram illustrating an example of a format of an accommodation destination switching instruction message;

FIG. 9 is a diagram illustrating an example of a format of a Face setting request message;

FIG. 10 is a diagram illustrating an example of a format of a Face setting response message;

FIG. 11 is a diagram illustrating an example of a sequence of operations of a communication system;

FIG. 12 is a diagram illustrating an example of operations of switching the accommodation destination node of a Publisher terminal;

FIG. 13 is a diagram illustrating an example of a sequence of operations of switching the accommodation destination node of a Publisher terminal;

FIG. 14 is a diagram illustrating an example of a sequence of operations of switching back the accommodation destination node of a Subscriber terminal;

FIG. 15 is a diagram illustrating an example of an extended forward information base (FIB);

FIG. 16 is a diagram illustrating an example of a terminal selection procedure using an extended FIB;

FIG. 17 is a diagram illustrating an example of an extended FIB;

FIG. 18 is a flowchart illustrating an example of operations of selecting a terminal based on delay constraints;

FIG. 19 is a diagram illustrating an example of a table in which communication traffic levels are registered; and

FIG. 20 is a flowchart illustrating an example of operations of selecting a terminal based on a communication traffic level.

### DESCRIPTION OF THE EMBODIMENTS

Nodes included in ICN perform routing on a per-content item basis. This raises an issue in that an increase in the number of content items to be communicated produces an increase in traffic between nodes, an increase in the number of entries of routing information, and the like, leading to an overload state of a node.

In one aspect, the present disclosure provides a recording medium, a communication method, and a communication device to resolve an overload state.

Embodiments will be described below with reference to the accompanying drawings.

### First Embodiment

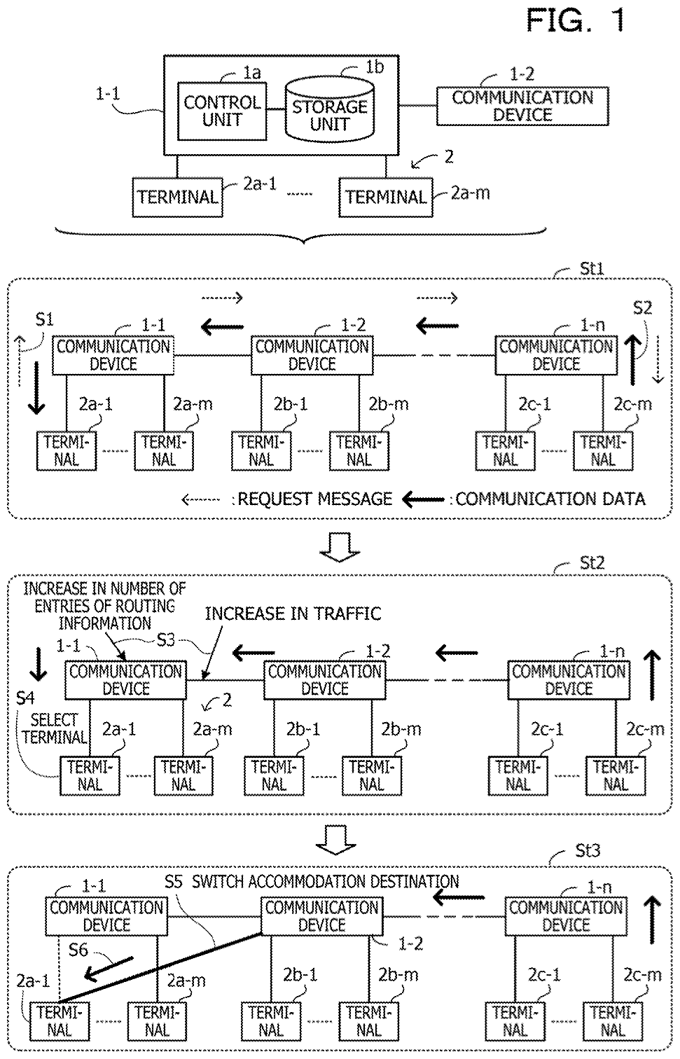

A first embodiment will be described with reference to FIG. 1. FIG. 1 is a diagram illustrating an example of a communication device. A communication device 1-1, which is a device coupled to ICN, includes a control unit 1a and a storage unit 1b, and accommodates a terminal group 2 including terminals 2a-1, . . . , 2a-m such that the terminal group 2 is subordinate to the communication device 1-1. A communication device 1-2 is adjacently coupled to the communication device 1-1.

The control unit 1a determines whether the operational state of its device (the communication device 1-1) is an overload state, When detecting that the communication device 1-1 is overloaded, the control unit 1a selects a certain terminal from the terminal group 2 accommodated by the communication device 1-1 and switches the accommodation destination of the certain terminal to a device (a communication device 1-2) adjacent to the communication device 1-1. The storage unit 1b stores routing information of communication data, operational information of devices, and so on.

Operations will be described using an example illustrated in FIG. 1. Communication devices 1-1, 1-2, . . . , 1-n are serially coupled. The communication devices 1-2, . . . , 1-n accommodate terminal groups in the same manner as the communication device 1-1. The communication device 1-2 accommodates terminals 2b-1, . . . , 2b-m, and the communication device 1-n accommodates terminals 2c-1, . . . , 2c-m.

The communication devices 1-2, . . . , 1-n have functions equivalent to those of the control unit 1a and the storage unit 1b, and the communication devices 1-1, . . . , 1-n operate in an autonomous and distributed manner.

A state St1 indicates an operational state before an overload of the communication device 1-1 is detected in the communication device 1-1, and a state St2 indicates an operational state when the overload is detected. A state St3 indicates an operational state when the accommodation destination device of a terminal is switched after the overload has been detected.

[Step S1] The terminal 2a-1 issues a request message for communication data (dotted-line arrows in the drawing). The request message is assumed to be routed based on respective pieces of routing information managed in the communication devices 1-1, . . . , 1-n and to be transmitted to the terminal 2c-m.

[Step S2] The terminal 2c-m outputs the requested communication data (bold solid-line arrows in the drawing). The communication data follows a path opposite to a path through which the request message has flown, and is transmitted to the terminal 2a-1. The communication data is acquired by the terminal 2a-1.

[Step S3] The control unit 1a in the communication device 1-1 monitors the operational state of the communication device 1-1 and determines whether the communication device 1-1 is overloaded. In this case, when the amount of traffic of communication data is greater than or equal to a threshold or when the number of entries of routing information of communication data is greater than or equal to a threshold, the control unit 1a detects that the communication device 1-1 is overloaded.

[Step S4] When detecting an overload, the control unit 1a in the communication device 1-1 selects a certain terminal for switching from the terminal group 2 accommodated by the communication device 1-1. For example, in the terminal group 2, the terminal 2a-1 that is requesting communication data is selected.

[Step S5] The control unit 1a in the communication device 1-1 switches the accommodation destination of the terminal 2a-1 to the communication device 1-2, which is adjacent to the communication device 1-1.

[Step S6] When arriving at the communication device 1-2, the communication data output from the terminal 2c-m is transmitted from the communication device 1-2 to the terminal 2a-1.

In this way, when an overload of a communication device is detected, a certain terminal is selected from a terminal group subordinate to the communication device, and the accommodation destination of the certain terminal is switched to a communication device adjacent to the communication device. Thus, the communication device may resolve its overload state.

### Second Embodiment

A second embodiment in which the functions of a communication device are applied to ICN will now be described. The case where the functions are applied to named data networking (NDN), which is a representative protocol of ICN, will be described below.

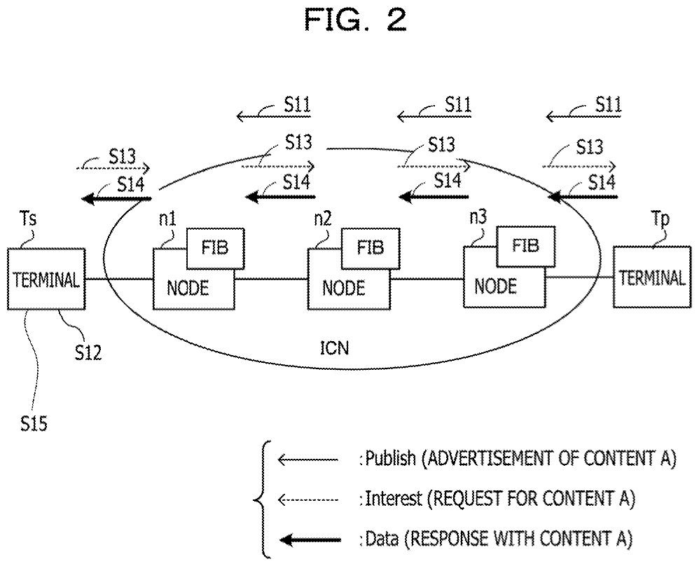

FIG. 2 is a diagram illustrating an example of operations in ICN. The outline of operations in ICN performed to acquire a content item after requesting the content item is illustrated. A system illustrated in FIG. 2 includes terminals Ts and Tp and nodes n1, n2, and n3. The terminal Ts is an information requester (Subscriber) who requests a content item, and the terminal Tp is an information provider (Publisher) who provides the requested content item.

The nodes n1, n2, and n3 are serially coupled and are included in ICN. The terminal Ts is coupled to the node n1 and the terminal Tp is coupled to the node n3. Nodes are coupled, and a node and a terminal are coupled, by a logical interface called Face described later.

Each of the nodes n1, n2, and n3 includes a forwarding information base (FIB). The FIB corresponds to a routing table for content transfer.

Publish. Interest, and Data messages are used in NDN. A Publish message is an advertising message for advertising what content item a terminal has. An Interest message is a request message for a content item. A Data message is a response message (containing a requested content item) to an Interest message.

[Step S11] The terminal Tp issues a Publish message to place, in ICN, an advertisement saying that the terminal Tp itself has content A. When receiving the Publish message, the nodes n1, n2, and n3 in ICN recognize the direction in which content A is located.

[Step S12] The terminal Ts issues an Interest message to request a content item by specifying the name (content A).

[Step S13] The Interest message is transmitted to the terminal Tp according to routing information registered in the FIBs in the nodes n1, n2, and n3.

[Step S14] When receiving the Interest message, the terminal Tp issues a Data message containing the requested content A. The Data message follows a path opposite to a path through which the Interest message has been transmitted, and is transmitted to the terminal Ts.

[Step S15] The terminal Ts receives the Data message and acquires content A included in the Data message.

In practice, the nodes n1, n2, and n3 include a mechanism for content storage (caching), although it depends on the operational policy whether each node caches content. Accordingly, although it has been described above that the terminal Tp possesses content A, for example, the node n3 is Publisher if the node n3 has content A. In this case, when the node n3 receives an Interest message, a Data message containing content A is transmitted from the node n3 to the terminal Ts.

<System Configuration>

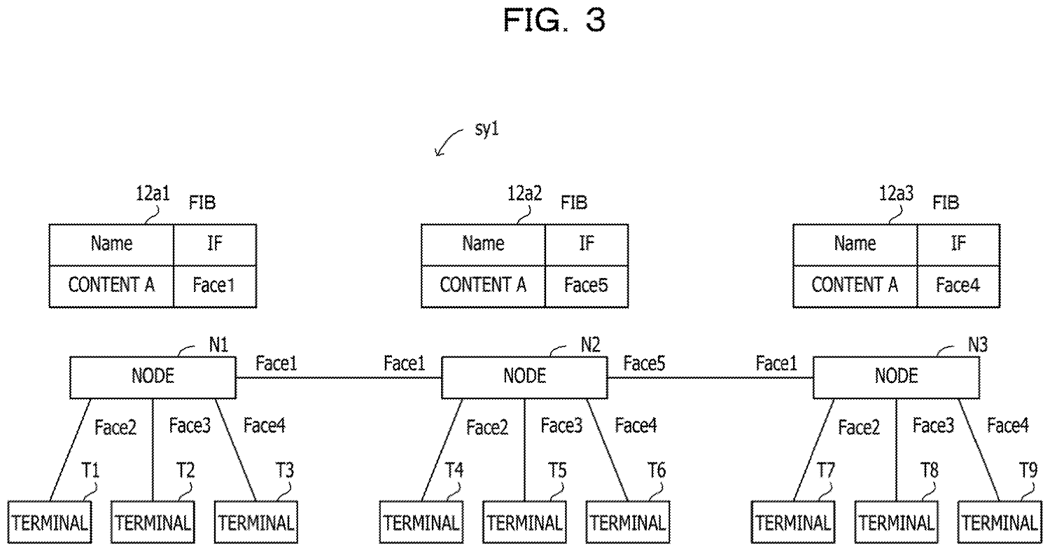

FIG. 3 is a diagram illustrating an example of a configuration of a communication system according to the second embodiment. A communication system sy1 includes nodes (ICN nodes) N1, N2, and N3 and terminals T1, . . . , T9.

The nodes N1, N2, and N3 have the functions of the communication device illustrated in FIG. 1 and operate in an autonomous and distributed manner. The terminals T1, . . . , T9 may be either Subscriber or Publisher. In the description given below, it is assumed that the terminal T1 is Subscriber and the terminal T9 is Publisher.

The nodes N1, N2, and N3 are serially coupled. The node N1 accommodates the terminals T1, T2, and 13, the node N2 accommodates the terminals T4, T5, and T6, and the node N3 accommodates the terminals T7, T8, and T9.

The nodes N1, N2, and N3 include logical network interfaces called Face. Face couples a node and a node or couples a node and a terminal. In the example illustrated in FIG. 3, the node N1 includes Face1 to Face4, the node N2 includes Face1 to Face5, and the node N3 includes Face1 to Face4. The identifiers of Face are unique to each node.

Face1 of the node N1 and Face1 of the node N2 are coupled, and Face5 of the node N2 and Face1 of the node N3 are coupled. The terminals T1, . . . , T9 are logically coupled to one node via a default path (a path set in advance) between the nodes and terminals.

In FIG. 3, the terminals T1, T2, and T3 are respectively coupled to Face2, Face3, and Face4 of the node N1, the terminals T4, T5, and T6 are respectively coupled to Face2, Face3, and Face4 of the node N2, and the terminals T7, T8, and T9 are respectively coupled to Face2, Face3, and Face4 of the node N3.

In the case where the terminal T9 advertises content A, a Publish message is output from the terminal T9. The Publish message is transmitted sequentially over the default path between nodes. In this case, the nodes N1, N2, and N3 create routing information for each content item based on interfaces that receive the Publish message, and register the routing information in FIBs,

The nodes N1, N2, and N3 respectively have FIBs 12a1, 12a2, and 12a3 corresponding to routing tables. In each of the FIBs 12a1, 12a2, and 12a3, a pair of Name (the name of the content item) and IF (the identifier of Face) leading to the content item, which indicates a path for the content item, is registered as routing information.

For an entry in an FIB, for example, when the node N3 recognizes that the terminal T9 has content A, (Name, IF)=(content A, Face4) is registered in the FIB 12a3 of the node N3.

When recognizing that content A is in the direction of Face5, the node N2 may acquire (access) content A through Face5, and therefore (Name, IF)=(content A, Face5) is registered in the FIB 12a2.

When recognizing that content A is in the direction of Face1, the node N1 may acquire content A through Face1, and therefore (Name, IF)=(content A, Face1) is registered in the FIB 12a1.

An Interest message issued from the terminal T1 is relayed and transmitted toward the terminal T9 according to routing information entered in the FIBs 12a1, 12a2, and 12a3 of the nodes N1, N2, and N3. The Data message issued from the terminal T9 follows a path opposite to a path through which the Interest message has flown, and is transmitted to the terminal T1.

<Hardware Configuration>

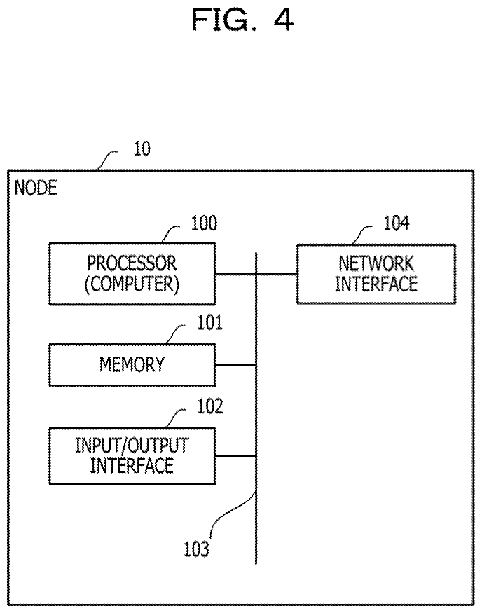

FIG. 4 is a diagram illustrating an example of a hardware configuration of a node. The nodes N1, N2, and N3 may each be called a node 10 when they are collectively referred to. The entire node 10 is controlled by a processor (computer) 100. The processor 100 corresponds to the control unit of the node 10.

A memory 101 and a plurality of peripheral devices are coupled to the processor 100 via a bus 103. The processor 100 may be a multiprocessor. The processor 100 is, for example, a central processing unit (CPU), a microprocessor unit (MPU), a digital signal processor (DSP), an application-specific integrated circuit (ASIC), or a programmable logic device (PLD). The processor 100 may be a combination of two or more of a CPU, an MPU, a DSP, an ASIC, and a PLD.

The memory 101 corresponds to a storage unit of the node 10 and, for example, is used as a main storage device. At least some of the operating system (OS) programs and application programs, which are executed by the processor 100, are temporarily stored in the memory 101. Various types of data for processing performed by the processor 100 are also stored in the memory 101.

The memory 101 is also used as an auxiliary storage device of the node 10, and stores OS programs, application programs, and various types of data. The memory 101 may include, as the auxiliary storage device, a semiconductor storage device, such as a flash memory or a solid state drive (SSD), or a magnetic recording medium, such as a hard disk drive (HDD).

The peripheral devices coupled to the bus 103 include an input/output interface 102 and a network interface 104. A monitor (for example, a light-emitting diode (LED) or a liquid crystal display (LCD)) that functions as a display device for displaying the state of the node 10 in accordance with an instruction from the processor 100 may be coupled to the input/output interface 102.

An information input device, such as a keyboard or a mouse, may also be coupled to the input/output interface 102. The input/output interface 102 transmit, to the processor 100, signals sent from the information input device.

The input/output interface 102 also functions as a communication interface for coupling the peripheral devices.

For example, an optical drive device that uses laser light or the like to read data recorded on an optical disk may be coupled to the input/output interface 102. Examples of the optical disk include a Blu-ray Disc (registered trademark), a compact disc read-only memory (CD-ROM), and a CD-recordable (R)/rewritable (RW).

A memory device and a memory reader/writer may also be coupled to the input/output interface 102. The memory device is a recording medium having a function to communicate with the input/output interface 102. The memory reader/writer is a device that writes data to a memory card or reads data from the memory card. The memory card is a card-type recording medium.

The network interface 104 is coupled to a network and performs network interface control. For example, a network interface card (NIC), a wireless local area network (LAN) card, or the like may be used as the network interface 104. Data received by the network interface 104 is output to the memory 101 and the processor 100.

With a hardware configuration as described above, processing functions of the node 10 may be realized. For example, the node 10 may perform communication processing according to the present disclosure by the processor 100 executing each of predetermined programs.

The node 10, for example, realizes the processing functions according to the present disclosure by executing a program recorded on a computer-readable recording medium. A program describing the content of processing to be executed by the node 10 may be recorded on various recording media.

For example, a program to be executed by the node 10 may be stored in an auxiliary storage device. The processor 100 loads at least part of the program in the auxiliary storage device into the main storage device and executes the program.

The program may be recorded on a portable recording medium, such as an optical disk, a memory device, or a memory card. The program stored the portable recording medium is executable, for example, after being installed in an auxiliary storage device under control of the processor 100. The processor 100 may read the program directly from the portable recording medium and execute the program.

<Functional Blocks>

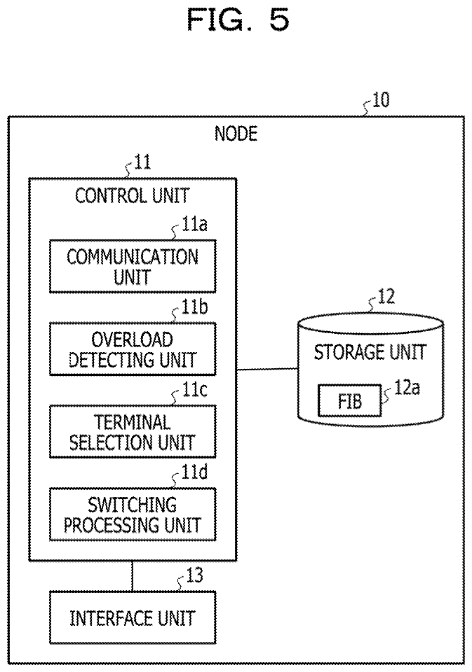

FIG. 5 is a diagram illustrating an example of functional blocks of a node. The node 10 includes a control unit 11, a storage unit 12, and an interface unit 13. The control unit 11 includes a communication unit 11a, an overload detecting unit 11b, a terminal selection unit 11c, and a switching processing unit 11d. The storage unit 12 stores an FIB 12a.

The communication unit 11a performs communication control for transmitting and receiving communication data, such as content, based on routing information of the FIB 12a. In the node 10, the FIB 12a is managed on a per-content item basis and routing is performed on the per-content item basis, and therefore an increase in the contained content items may lead to an overload state.

Therefore, the overload detecting unit 11b detects whether the operational state of its node is an overload state. The overload detecting unit 11b detects an overload, for example, based on an increase in traffic between nodes or an increase in the number of entries of routing information registered in a routing table.

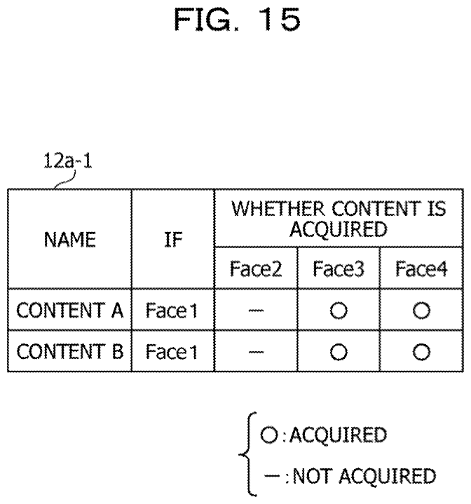

When an overload is detected, the terminal selection unit 11c selects, from a terminal group accommodated by its node, a certain terminal. The terminal selected as a terminal for switching is a Subscriber terminal, which is requesting content, or a Publisher terminal, which is providing the content. Alternatively, a target terminal is selected based on a selection method described later with reference to FIG. 15 and the following drawings.

The switching processing unit 11d instructs the selected terminal to switch the logical interface so that the accommodation destination of the selected terminal is switched to a node adjacent to the node of the switching processing unit 11d. Alternatively, when the node of the switching processing unit 11d becomes a new accommodation destination node, the switching processing unit 11d performs coupling processing of a logical interface for coupling between the node and the selected terminal.

The storage unit 12 stores table information of the FIB 12a and the like and manages routing information and the like on a per-content item basis. The interface unit 13 performs interface control of communication data including a content item, control information for device operations, and so on.

The control unit 11 is implemented by the processor 100 illustrated in FIG. 4, and the storage unit 12 is implemented by the memory 101 illustrated in FIG. 4. The interface unit 13 is implemented by the input/output interface 102 or the network interface 104 illustrated in FIG. 4.

<Operations of System>

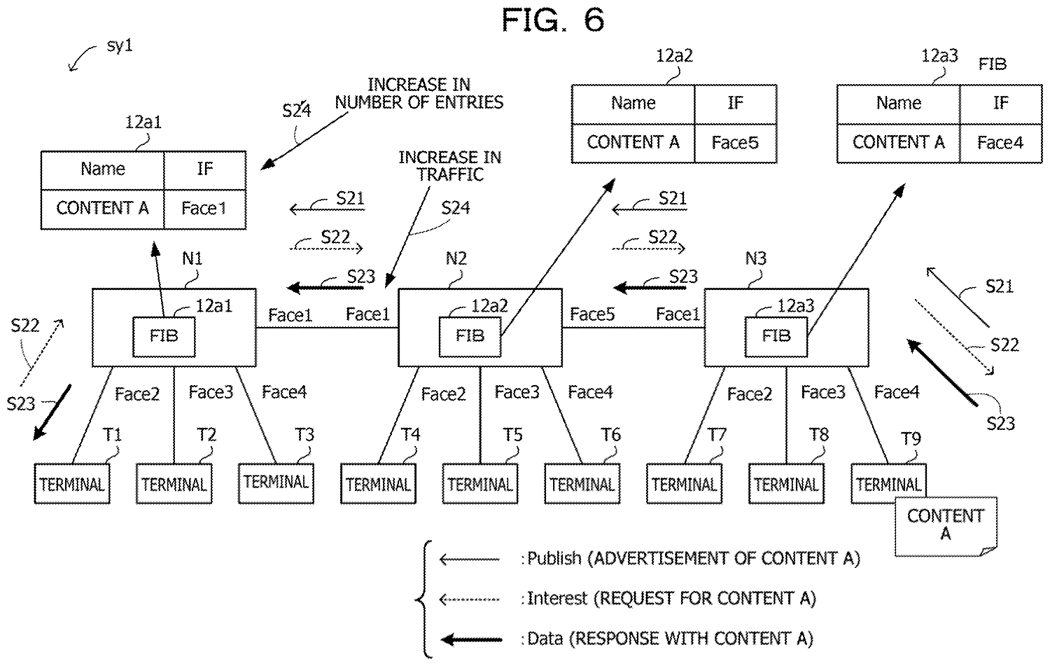

FIG. 6 is a diagram illustrating an example of operations during content transfer. It is assumed that the terminal T9 serving as Publisher has content A and the terminal T1 serving as Subscriber requests content A.

In the communication system sy1, a Publish message of content A is issued from the terminal T9, and a request for acquiring content A is issued from the terminal T1. The FIBS 12a1, 12a2, and 12a3 are generated in the nodes N1, N2, and N3, respectively. (Name, IF)=(content A, Face1) is registered in the FIB 12a1, (Name, IF)=(content A, Face5) is registered in the FIB 12a2, and (Name, IF)=(content A, Face4) is registered in the FIB 12a3.

[Step S21] The terminal T9 issues a Publish message advertising that the terminal T9 has content A. The Publish message issued from the terminal T9 is transmitted to the node N3. The Publish message is further transmitted from the node N3 to the node N2 and from the node N2 to the node N1. Based on the received Publish message, the nodes N1, N2, and N3 register routing information for content A in the FIBs 12a1, 12a2, and 12a3, respectively.

[Step S22] The terminal T1 issues an Interest message specifying content A to make a content request. The Interest message issued from the terminal T1 is transmitted to the node N1.

Based on the FIB 12a1, the node N1 transmits the Interest message to the node N2. Based on the FIB 12a2, the node N2 transmits the Interest message to the node N3. Based on the FIB 12a3, the node N3 transmits the Interest message to the terminal T9.

[Step S23] When receiving the Interest message, the terminal T9 issues a Data message containing the requested content A. The Data message follows a path opposite to a path through which the Interest message has been transmitted, and is transmitted to the terminal T1.

[Step S24] It is assumed that the traffic between the nodes N1 and N2 increases or the number of entries in the FIB of the node N1 increases, such that the node N1 becomes an overload state.

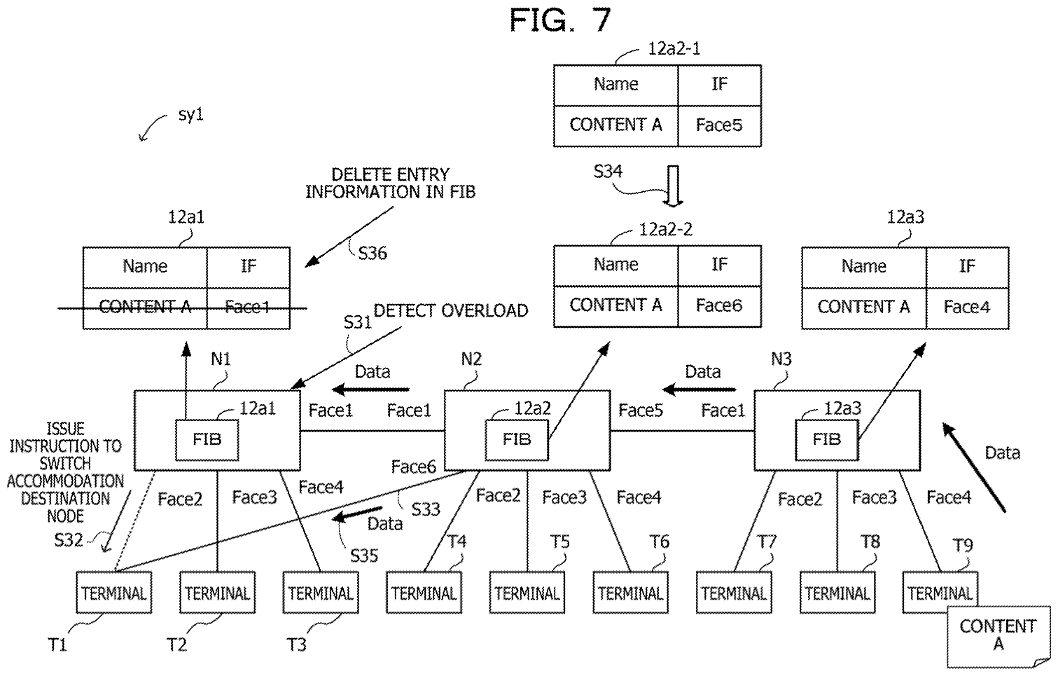

FIG. 7 is a diagram illustrating an example of operations when an overload is detected and switching of the accommodation destination node of a terminal is performed. In the communication system sy1, when a node in an overload state is detected, logical switching processing for the accommodation destination node of a terminal is performed in order to resolve the overload state.

[Step S31] The node N1 compares the amount of traffic of a path between the nodes N1 and N2 with a threshold. When the amount of traffic is greater than or equal to the threshold, the node N1 detects that the node N1 is in an overload state. Alternatively, the node N1 compares the number of entries of routing information accommodated in the FIB 12a1 with a threshold. When the number of entries is greater than or equal to the threshold, the node N1 detects an overload state.

[Step S32] The node N1 selects, from the terminals T1, T2, and T3 coupled to the node N1 itself, a terminal for switching of the accommodation destination node. The node N1 is assumed to have selected the terminal T1 serving as Subscriber. The node N1 notifies the terminal T1 of the switching destination information of a new accommodation destination node (assumed as the node N2). The switching destination information includes, for example, the IP address and the port number of the node N2.

[Step S33] When receiving the switching destination information, the terminal T1 sets a Face interface to the node N2 to change the accommodation destination to the node N2.

[Step S34] The node N2 rewrites IF corresponding to content A, from Face5 to Face6, between FIBs (rewriting from an FIB 12a2-1 to an FIB 12a2-2).

[Step S35] After the change of the accommodation destination node, the Data message containing content A is transmitted from the node N2, instead of the node N1, to the terminal T1.

[Step S36] The node N1 deletes entry information registered in the FIB 12a1 corresponding to content A of the terminal T1.

As described above, each of the nodes N1, N2, and N3 monitors its operational state. If it is determined that the node itself is overloaded, the accommodation destination of the selected terminal (Subscriber) subordinate to the node is switched to a node on the upstream side (closer to Publisher). For example, a node that accommodates a terminal of interest is switched to a node closer to Publisher. The entry information in the FIB corresponding to the terminal for which switching of the accommodation destination has been performed is deleted.

Performing such a control may reduce an increase in the communication traffic concentrated on a specific node and an increase in the number of entries in an FIB, effectively resolving an overload state of a node without causing obstacles, such as a communication interruption and a communication delay. Optimal operations (such as an increase in the number of requests for content accommodation) of the entire system may be achieved.

<Message Format>

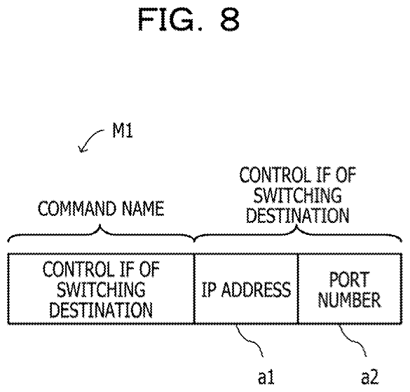

FIG. 8 is a diagram illustrating an example of a format of an accommodation destination switching instruction message. An accommodation destination switching instruction message M1 is a message issued from a node to a terminal (which may be hereinafter called a selected terminal) selected for switching of the accommodation destination node, and instructs the selected terminal to switch the accommodation destination node.

The accommodation destination switching instruction message M1 includes a command name and a control IF of the switching destination. The command name is an accommodation destination switching instruction, and the control IF of the switching destination includes an IP address a1 and a port number a2 of a node serving as the switching destination.

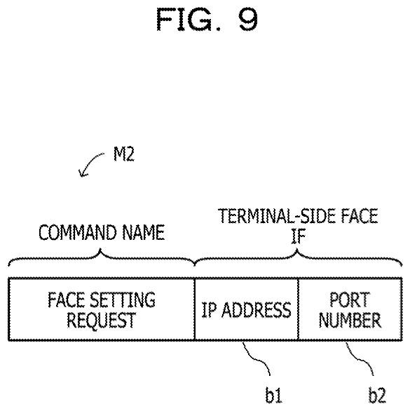

FIG. 9 is a diagram illustrating an example of a format of a Face setting request message. A Face setting request message M2 is issued from the selected terminal toward a node serving as the switching destination, and is a message that requests setting of a new Face interface.

The Face setting request message M2 includes a command name and terminal-side Face IF. The command name is a Face setting request. The terminal-side Face IF represents an end point on the terminal side of Face requested to be set, and includes an IP address b1 and a port number b2 at the end point.

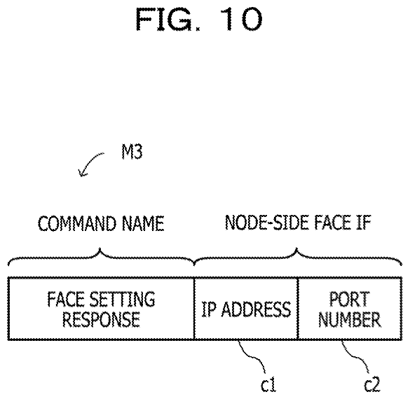

FIG. 10 is a diagram illustrating an example of a format of a Face setting response message. A Face setting response message M3 is issued from a node serving as the switching destination toward the selected terminal, and is a response message to a Face setting request.

The Face setting response message M3 includes a command name and node-side Face IF. The command name is a Face setting response. The node-side Face IF represents an end point on the node side of Face to be set, and includes an IP address c1 and a port number c2 at the end point.

The IP address a1 of the accommodation destination switching instruction message M1 and the IP address c1 of the Face setting response message M3 share the same address. The port number a2 of the accommodation destination switching instruction message M1 and the port number c2 of the Face setting response message M3 are different in principle.

Although not illustrated in the drawing, an ACK message (which may be hereinafter called a Face setting completion message) is transmitted from the selected terminal to a node serving as the switching source. This message is a message that, in response to receiving a response from a node serving as the switching destination, the selected terminal transmits to a node serving as the switching source in order to provide a notification of a switching result.

<Sequence of Operations>

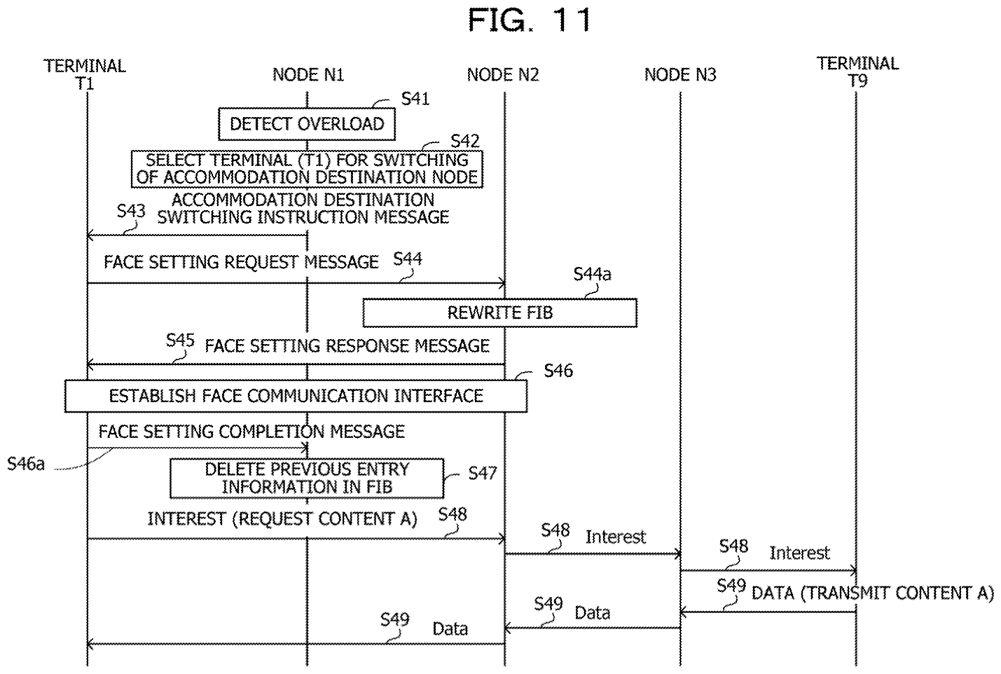

FIG. 11 is a diagram illustrating an example of a sequence of operations of a communication system.

[Step S41] The node N1 detects its overload.

[Step S42] The node N1 selects a terminal (the terminal T1) for switching of the accommodation destination node.

[Step S43] The node N1 transmits the accommodation destination switching instruction message M1 to the terminal T1.

[Step S44] The terminal T1 transmits the Face setting request message M2 to the node N2.

[Step S44a] The node N2 rewrites the FIB 12a2.

[Step S45] The node N2 transmits the Face setting response message M3 to the terminal T1.

[Step S46] A Face communication interface is established'between the terminal T1 and the node N2.

[Step S46a] The terminal T1 transmits a Face setting completion message to the node N1.

[Step S47] The node N1 deletes the previous entry information (content A, Face1) in the FIB 12a1.

[Step S48] The terminal T1 issues an Interest message for acquiring content A. The Interest message is transmitted from the terminal T1 to the node N2, from the node N2 to the node N3, and from the node N3 to the terminal T9.

[Step S49] The terminal T9 issues a Data message containing content A. The Data message is transmitted from the terminal T9 to the node N3, from the node N3 to the node N2, and from the node N2 to the terminal T1.

Although description has been given of operations of the node N1, in practice, all the nodes perform the same or similar operations in an autonomous and distributed manner so as to achieve an optimal configuration of the entire system. Accordingly, when an overload is further detected in the node N2 during operations after the accommodation destination of the terminal T1 has been changed to the node N2, the node N2 may perform the same or similar control. This enables the accommodation destination of the terminal T1 to be switched to, for example, the node N3.

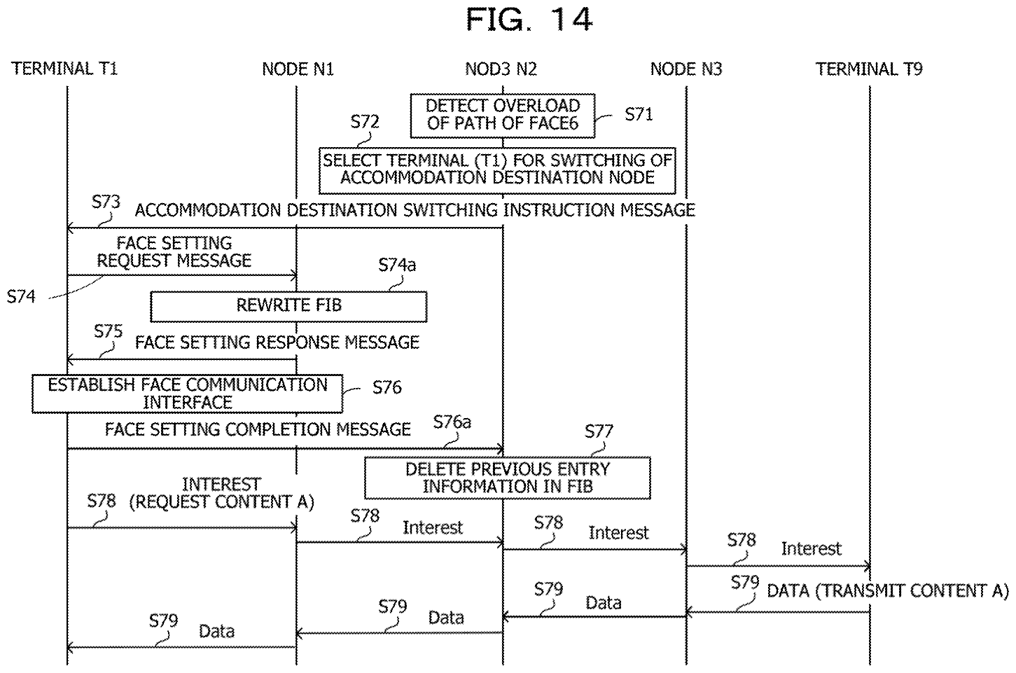

Alternatively, during operations after changing the accommodation destination of the terminal T1 to the node N2, the node N2 is assumed to have detected that the traffic between the nodes N2 and N3 is greater than the traffic between the nodes N1 and N2. In this case, the node N2 may switch back the accommodation destination of the terminal T1 to the node N1 to cause the node N1 to accommodate again the terminal T1 (described later with reference to FIG. 14).

<Switch Accommodation Destination Node of Publisher Terminal>

Although switching of the accommodation destination node of a Subscriber terminal has been described above, the node that accommodates a Publisher terminal may be switched to a node located more downstream (closer to Subscriber).

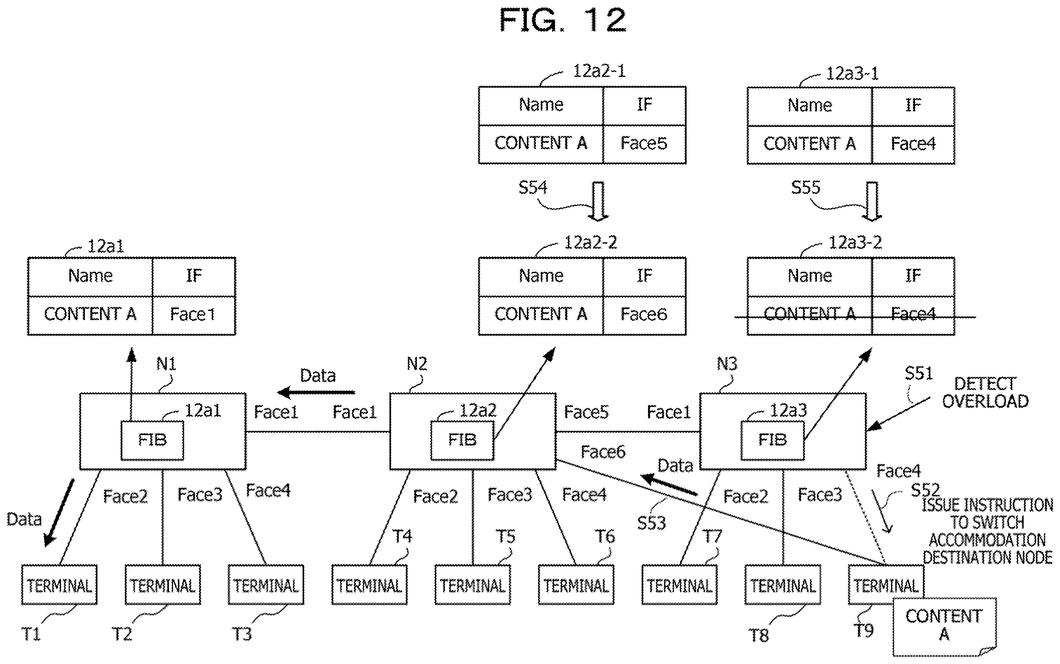

FIG. 12 is a diagram illustrating an example of operations of switching the accommodation destination node of a Publisher terminal. A request for acquiring content A is issued from the terminal T1, and FIBs 12a1, 12a2-1, and 12a3-1 are generated in the nodes N1, N2, and N3, respectively. (Name, IF)=(content A, Face1) is registered in the FIB 12a1, (Name, IF)=(content A, Face5) is registered in the FIB 12a2-1, and (Name, IF)=(content A, Face4) is registered in the FIB 12a3-1.

The node N3 is assumed to detect an overload and to switch the accommodation destination of the subordinate terminal T9 to the node N2.

[Step S51] The node N3 compares the amount of traffic of a path between the nodes N2 and N3 with a threshold. When the amount of traffic is greater than or equal to the threshold, the node N3 detects that the node N3 is in an overload state. Alternatively, the node N3 compares the number of entries of routing information accommodated in the FIB 12a3-1 with a threshold. When the number of entries is greater than or equal to the threshold, the node N3 detects an overload state.

[Step S52] The node N3 selects, from the terminals T7, T8, and T9 coupled to the node N3 itself, the terminal T9 that outputs content A, and notifies the terminal T9 of the switching destination information of a new accommodation destination node (assumed as the node N2). The switching destination information includes, for example, the IP address and the port number of the node N2.

[Step S53] When receiving the switching destination information, the terminal T9 sets Face for the node N2 to change the accommodation destination to the node N2. For example, Face is set for the node N2, allowing the terminal T9 to transmit content A to the node N2.

[Step S54] The node N2 rewrites IF corresponding to content A, from Face5 to Face6, between FIBs (rewriting from the FIB 12a2-1 to the FIB 12a2-2).

[Step S55] The node N3 deletes entry information in the FIB corresponding to content A for the terminal T9 for which switching of the accommodation destination has been performed, to delete the setting of Face for the terminal T9 (rewriting from the FIB 12a3-1 to an FIB 12a3-2).

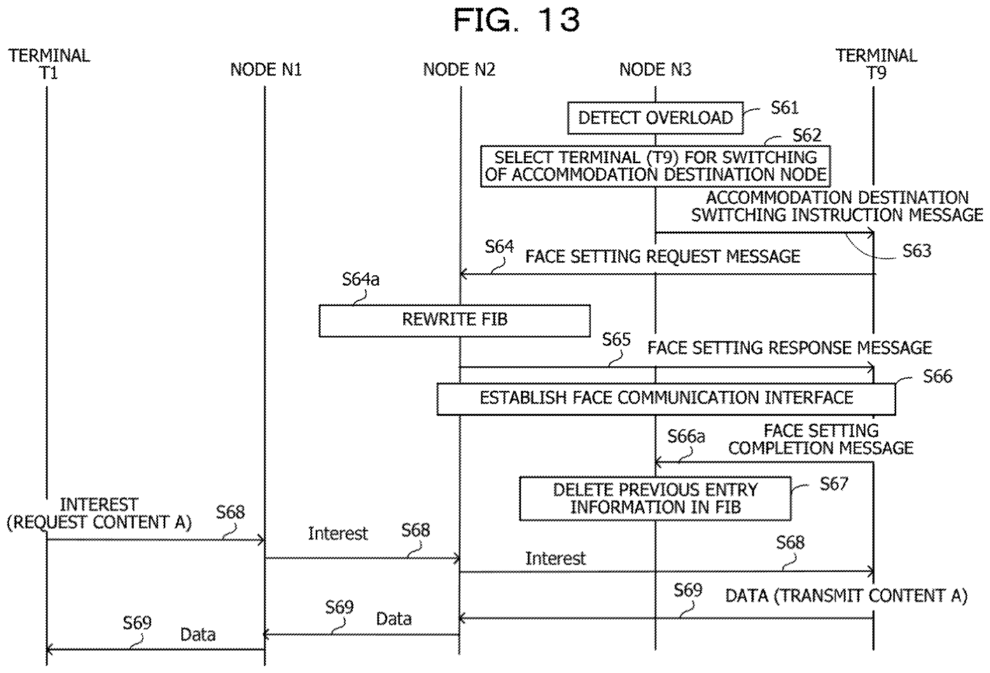

FIG. 13 is a diagram illustrating an example of a sequence of operations of switching the accommodation destination node of a Publisher terminal.

[Step S61] The node N3 detects its overload.

[Step S62] The node N3 selects a terminal (the terminal T9) for switching of the accommodation destination node.

[Step S63] The node N3 transmits the accommodation destination switching instruction message M1 to the terminal T9.

[Step S64] The terminal T9 transmits the Face setting request message M2 to the node N2.

[Step S64a] The node N2 rewrites the FIB.

[Step S65] The node N2 transmits the Face setting response message M3 to the terminal T9.

[Step S66] A Face communication interface is established between the terminal T9 and the node N2.

[Step S66a] The terminal T9 transmits a Face setting completion message to the node N3.

[Step S67] The node N3 deletes (content A, Face4), which is the previous entry information in the FIB 12a3-1.

[Step S68] The terminal T1 issues an Interest message for acquiring content A. The Interest message is transmitted from the terminal T1 to the node N1, from the node N1 to the node N2, and from the node N2 to the terminal T9.

[Step S69] The terminal T9 issues a Data message containing content A. The Data message is transmitted from the terminal T9 to the node N2, from the node N2 to the node N1, and from the node N1 to the terminal T1.

<Switch Back Accommodation Destination Node of Subscriber Terminal>

FIG. 14 is a diagram illustrating an example of a sequence of operations of switching back the accommodation destination node of a Subscriber terminal. An example is illustrated in which the transfer path of content A, which has been switched to a path in the sequence of the terminal T9 −>the node N3−>the node N2−>the terminal T1 illustrated in FIG. 7, is switched back to a path in the sequence of the terminal T9−>the node N3−>the node N2−>the node N1−>the terminal T1, in response to, for example, congestion in the path between the node N2 and the terminal T1 identified by Face6.

[Step S71] The node N2 monitors the traffic of its Face. When detecting that the amount of traffic of Face6 is greater than or equal to a threshold, the node N2 detects an overload of the path of Face6.

[Step S72] The node N2 selects a terminal for switching of the accommodation destination. The node N2 selects the terminal T1 corresponding to Face6 as a terminal for switching (switching back) of the accommodation destination.

[Step S73] The node N2 transmits the accommodation destination switching instruction message M1 to the terminal T1.

[Step S74] The terminal T1 transmits the Face setting request message M2 to the node N1.

[Step S74a] The node N1 rewrites the FIB.

[Step S75] The node N1 transmits the Face setting response message M3 to the terminal T1.

[Step S76] A Face communication interface is established between the terminal T1 and the node N1.

[Step S76a] The terminal T1 transmits a Face setting completion message to the node N2.

[Step S77] The node N2 deletes the previous entry information in the FIB.

[Step S78] The terminal T1 issues an Interest message for acquiring content A. The Interest message is transmitted from the terminal T1 to the node N1, from the node N1 to the node N2, from the node N2 to the node N3, and from the node N3 to the terminal T9.

[Step S79] The terminal T9 issues a Data message containing content A. The Data message is transmitted from the terminal T9 to the node N3, from the node N3 to the node N2, from the node N2 to the node N1, and from the node N1 to the terminal T1.

In this way, the accommodation destination of the terminal T1 is switched back to the node N1, so that the node N1 accommodates the terminal T1 again. This may resolve the overload state of the node N2 and optimize the operations of the entire system.

<Select Terminal with High Probability to Perform Communication for Content Acquisition>

In a node in which an overload is detected, when a terminal for switching of the accommodation destination node is selected, a terminal with a high probability to perform communication for content acquisition in the future may be selected. In this case, an extended FIB as illustrated in FIG. 15 is used.

FIG. 15 is a diagram illustrating an example of an extended FIB. In an FIB 12a-1, as items, Whether Content Is Acquired is set in addition to Name and IF described above. In the FIB 12a-1, it is recorded on a per-content item basis whether a content item has been transferred to (acquired by) subordinate terminals. For example, “o” in Whether Content Is Acquired indicates that the content item has been transferred to (Face of) the terminal, and “-” indicates that the content item has not been transferred.

A terminal (Face) with a large number of “-” symbols is selected as a terminal for switching of the accommodation destination node. This is based on the estimation that a terminal that has not performed content acquisition has a high probability to perform content acquisition in the future, and conversely a terminal that has performed content acquisition has a low probability to again perform content acquisition.

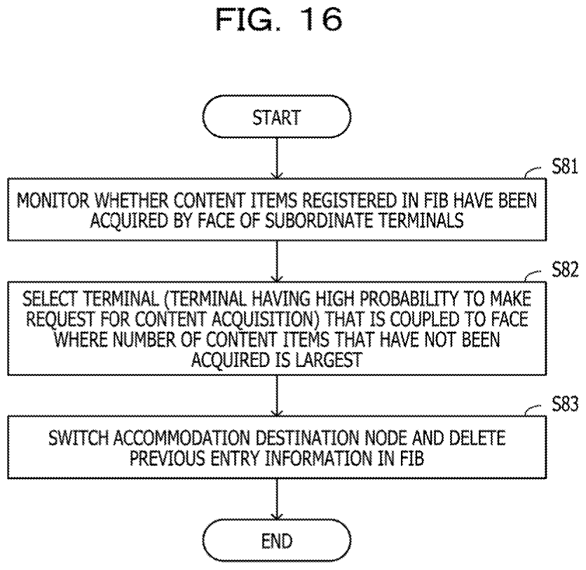

FIG. 16 is a diagram illustrating an example of a terminal selection procedure using an extended FIB.

[Step S81] The node N1 manages content items registered in the FIB 12a-1 by monitoring whether the content items are acquired by Face (Face2, Face3, and Face4) of the subordinate terminals.

[Step S82] The node N1 selects, from the FIB 12a-1, Face2 where the number of content items that have not been acquired is largest. The node N1 determines, as a new accommodation destination of a terminal corresponding to Face2, a node (the node N2 in this example) corresponding to the destination IF (one listed most frequently, Face1 in this example) of these content items. For example, a terminal having a high probability to make a request for content acquisition is selected,

[Step S83] The node N1 switches the accommodation destination node and then deletes the corresponding entry information in the FIB. When new requests (Interest messages) for acquiring these content items are issued, the content items are sequentially transmitted to the default path.

In this way, a terminal with a high probability to perform communication for content acquisition is selected. This may resolve an overload state of a node and avoid an overload state of the node in the future.

<Select Terminal Based on Delay Constraints>

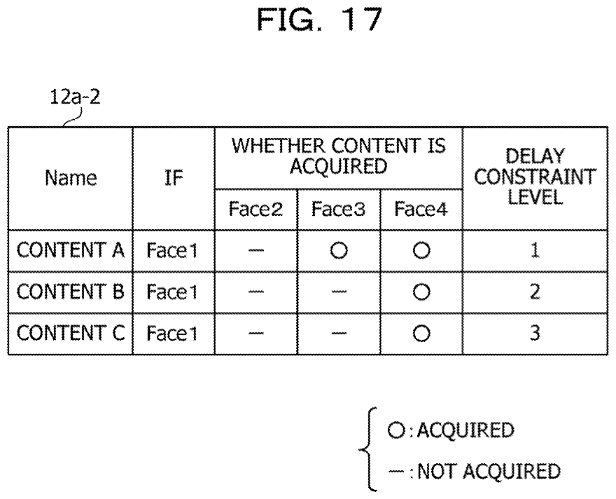

As a way to select a terminal, a content item with a small delay tolerance (strict delay constraints) for communication may be determined from content names registered in an FIB, and thus a terminal having a high probability to acquire the determined content item may be selected. In this case, an extended FIB as illustrated in FIG. 17 is used.

FIG. 17 is a diagram illustrating an example of an extended FIB. An FIB 12a-2 includes an item of Delay Constraint Level in addition to the items of Name, IF, and Whether Content Is Acquired. The delay constraint level represents a level of delay constraints on a content item. For example, the smaller the number, the smaller the delay tolerance (the smaller the number, the more strict the delay constraints).

The value of the delay constraint level is determined depending on the type of a content item. For example, the content item of the delay constraint level=1 is associated with real-time content of voice and video, the content item of the delay constraint level=2 with business document and worksheet content, and the content item of the delay constraint level=3 with Web general content.

At the time when the Publisher terminal advertises the content item, a network is notified of the value of a delay constraint level, together with a content name, Each node registers the value, together with the content name and the destination IF, in the FIB.

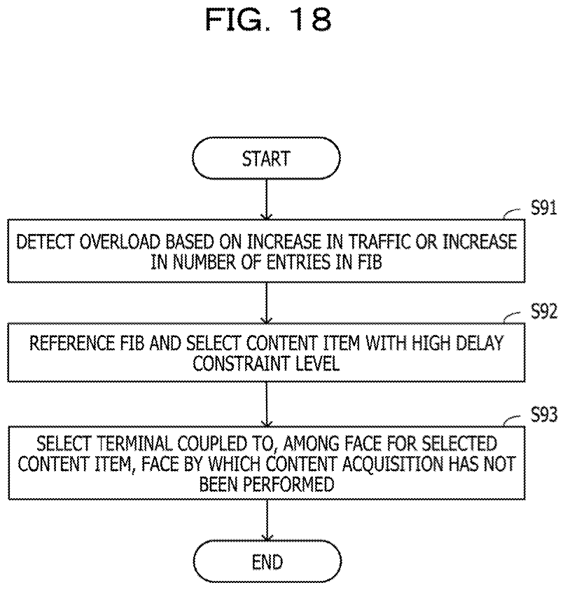

FIG. 18 is a flowchart illustrating an example of operations of selecting a terminal based on delay constraints.

[Step S91] The node N1 detects its overload based on an increase in traffic or an increase in the number of entries in the FIB.

[Step S92] The node N1 references the FIB 12a-2 and selects a content item with a high delay constraint level. For example, content A with a delay constraint level having a value of one.

[Step S93] The node N1 selects a terminal coupled to, among Face (Face2, Face3, and Face4) of terminals for content A, Face by which content acquisition has not been performed, as a terminal for switching (the terminal T1 coupled to Face2 in this example), and determines, as a new accommodation destination of this terminal, a node (the node N2 in this example) corresponding to the destination IF (Face6 in this example) for the content item.

In this way, a terminal having a high probability to acquire content in a manner sensitive to delays is selected. This may resolve an overload in a node serving as the switching source. End-to-end delays for content acquisition are preferentially reduced, and therefore the real-time capability of content transfer may be improved.

<Select Terminal Based on Level of Communication Traffic>

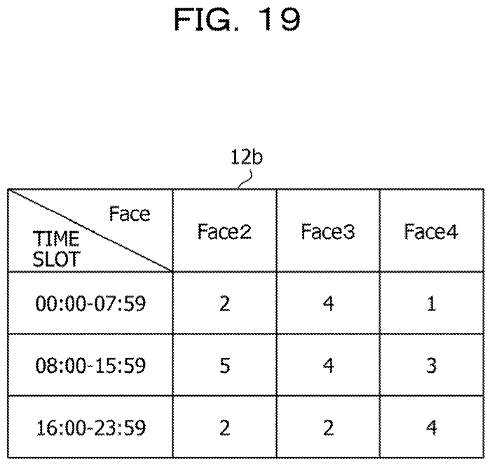

As a way to select a terminal, the terminal may be selected based on the level of communication traffic. FIG. 19 is a diagram illustrating an example of a table in which communication traffic levels are registered. A table 12b illustrates an example of table registrations the node N1 has. The vertical items are time slots, and the horizontal items are Face corresponding to the accommodated terminals (the table 12b is stored in the storage unit 12). The values in the table represent the levels of communication traffic generated by the terminals in time slots on a five-level scale, where five is the largest amount of traffic.

For example, in a time slot of 00:00-07:59, the traffic of a terminal (the terminal T1) coupled to Face2=2, the traffic of a terminal (the terminal T2) coupled to Face3=4, and the traffic of a terminal (the terminal T3) coupled to Face4=1.

The values of traffic levels are statistically extracted by collecting and analyzing past communication history. For example, a server that collects and analyzes communication history is separately provided, regularly collects and analyzes communication logs measured by each node, creates a table corresponding to FIG. 19, and places the table at each node.

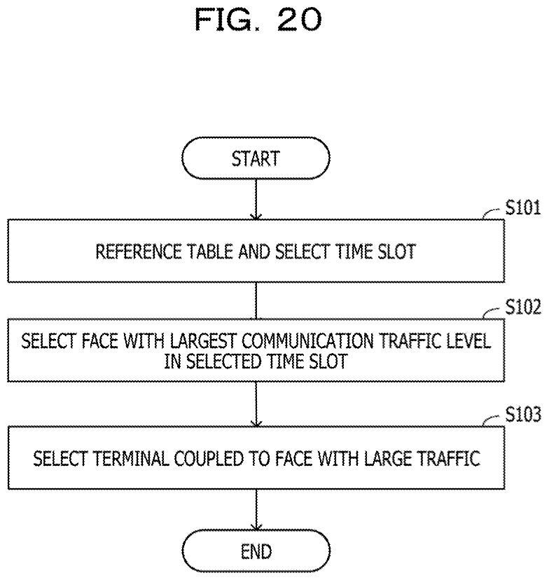

FIG. 20 is a flowchart illustrating an example of operations of selecting a terminal based on a communication traffic level.

[Step S101] The node N1 references the table 12b and selects a time slot including the current time point. For example, the node N1 is assumed to have selected the time slot of 00:00-07:59.

[Step S102] The node N1 selects Face with the communication traffic level having the largest value in the selected time slot.

[Step S103] The node N selects a terminal coupled to Face with the large traffic. In this example, in the time slot of 00:00-07:59, the communication traffic of the terminal T2 is largest (traffic=4), and therefore the terminal T2 is selected. In this way, resolution of an overload state and reduction of traffic may be attained by selecting a terminal with large communication traffic within a certain time slot.

Other than the terminal selection ways as described above, for example, the priorities for node switching may be assigned to terminals subordinate to a node, and a terminal with a high priority (for example, a terminal dedicated to business processing) may be selected. Alternatively, a terminal may be randomly selected from terminals subordinate to a node. In this case, one terminal is randomly selected from Face for accommodating subordinate terminals, and switching of the accommodation destination node of the selected terminal is performed.

The processing functions of the communication device and the node according to the present disclosure may be achieved by a computers In this case, there is provided a program that describes processing content of functions to be included in the communication device and the node. When the program is executed by a computer, the processing functions described above are implemented on the computer.

The program that describes the processing content may be recorded on a computer-readable recording medium. Examples of the computer-readable recording medium include a magnetic storage unit, an optical disk, a magneto-optical recording medium, and a semiconductor memory. Examples of the magnetic storage unit include a hard disk device (HDD), a floppy disk (FD), and a magnetic tape. Examples of the optical disk include a CD-ROM/RW. Examples of the magneto-optical recording medium include a magneto-optical (MO) disk.

When a program is to be distributed, for example, portable recording media, such as CD-ROMs, on which the program is recorded are sold. The program may be stored in a storage unit of a server computer, and the program may be transferred from the server computer to another computer via a network.

The computer executing a program stores, for example, in its storage unit, a program recorded on the portable recording medium or a program transferred from the server computer. The computer then reads, from its storage unit, the program and executes processing according to the program. The computer may also read the program directly from the portable recording medium and execute processing according to the program.

Each time a program is transferred from a server computer coupled via a network to a computer, the computer may execute processing according to the received program. At least some of the processing functions described above may be achieved by an electronic circuit, such as a DSP, an ASIC, or a PLD.

Although embodiments have been illustrated, the configurations of units illustrated in the embodiments may be replaced with other units having the same or similar functions. Any other elements and processes may be added. Any two or more configurations (features) of the embodiments described above may be combined together.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A device comprising:
a memory; and
a processor coupled to the memory and configured to:
when detecting that an operational state of the device coupled to information-centric networking is an overload state, select a certain terminal from a terminal group accommodated by the device; and
switch an accommodation destination of the certain terminal to another device adjacent to the device.

2. The device according to claim 1, wherein the memory stores a table for managing routing information of communication data, and the processor detects an overload of the device when an amount of traffic of the communication data is greater than or equal to a threshold or when a number of entries in the table of the routing information is greater than or equal to a threshold.

3. The device according to claim 2, wherein the processor deletes the routing information for the certain terminal from the table after switching the accommodation destination of the certain terminal.

4. The device according to claim 2, wherein the processor selects, as the certain terminal, a terminal that is requesting the communication data, in the terminal group.

5. The device according to claim 2, wherein the processor selects, as the certain terminal, a terminal that is providing the communication data, in the terminal group.

6. The device according to claim 2, wherein the processor controls to monitoring an acquisition state of the communication data for the terminal group and selects, as the certain terminal, a terminal that has not acquired a largest number of pieces of the communication data, in the terminal group.

7. The device according to claim 2, wherein the processor selects, as the certain terminal, a terminal having a smallest delay tolerance for the communication data in the terminal group,

8. The device according to claim 2, wherein the processor manages, for each certain time slot, log information of the communication data of the terminal group, detects a terminal having a largest amount of traffic in the terminal group from the log information in the time slot including a time point at which the overload is detected, and selects the detected terminal as the certain terminal.

9. The device according to claim 1, wherein the processor, when detecting the overload state after the accommodation destination of the certain terminal is switched, switches back the accommodation destination of the certain terminal to a device serving as a switching source before switching for the certain terminal.

10. A communication method comprising:
when detecting that an operational state of a device coupled to information-centric networking is an overload state, selecting a certain terminal from a terminal group accommodated by the device; and
switching an accommodation destination of the certain terminal o another device adjacent to the device.
